(19) United States
(12) Patent Application Publication
(10) Pub. No.: US 2003/0115243 A1
(43) Pub. Date: Jun. 19, 2003

(54) Distributed process execution system and method

(75) Inventor: Ned M. Smith, Beaverton, OR (US)

Correspondence Address: Schwegman, Lundberg, Woessner & Kluth, P.A., P.O. Box 2938, Minneapolis, MN, 55402, US

(73) Assignee: Intel Corporation

(21) Appl. No.: 10/025,069

(22) Filed: Dec. 18, 2001

(51) Int. Cl. G06F 9/00

(52) U.S. Cl. 709/104; 709/106

(57) ABSTRACT

A method of processing data, an information processing system, and a number of articles including a machine-accessible medium, are disclosed. The method may include specifying a process definition task structure, dynamically binding a plurality of selected resources to a plurality of tasks, configuring a cache, scheduling the resources to execute the plurality of tasks, and executing the tasks. The system may include a specification module, a binding module, a cache, and a scheduling module, each module capable of being communicatively coupled to the others. One of the disclosed articles may include a machine-accessible medium having associated data, wherein the data, when accessed, results in a machine performing the actions of specifying a process body including a plurality of tasks and specifying a process state having execution state information.

### FIELD OF THE INVENTION

The present invention relates generally to apparatus, systems, and methods used to increase the efficiency of processing of information. More particularly, the present invention relates to discovering, coordinating, and directing the use of available computational resources as they operate on selected data and other process elements.

### BACKGROUND INFORMATION

The computer industry constantly strives to provide hardware and software which perform according to the increasing expectations of consumers. One aspect of improved computer performance involves the speed at which instructions and data can be accessed. Another is the speed at which resources to act upon the data can be utilized. The more quickly instructions and data can be retrieved, and the more quickly appropriate resources can be located and accessed, the more efficiently data can be processed. Distributing tasks among multiple resources can also have a major effect on processing efficiency.

To solve one aspect of the problem, the concept of a cache has been developed as a mechanism for temporarily storing and maintaining frequently-accessed information, so that a resource, such as a processor, can load and store the information much more quickly than would be possible by interacting directly with long-term memory. However, cache usage is not without problems. There is always the question of what information should be stored in the cache, how often the information should be updated, and how long various processes which need to act upon the information should have to wait to access it.

Problems also exist with respect to the location and coordination of resources. Resources often have unique data format requirements, which may not be static. In fact, the resources themselves may change in terms of capability and availability. As global telecommunications networks continue to expand, and servers, desktops, and handheld computing devices communicate with increasing frequency, managing resource inter-communication to include common data and messaging formats becomes more challenging. Information technology administrators face a daunting task in attempting to coordinate applications vendors and equipment manufacturers so as to ensure that messaging and queuing technology enable application-to-application integration. As the work to integrate software and hardware continues, tools are needed to automate the capture and management of complex interactions between humans, software, and machines. This is especially true when changes in processing requirements, as well as the number and kind of available resources, are considered.

Finally, workflow systems, which have evolved to assist in the orchestration of information technology employee activity, are not fully automated. While processing objectives can be decomposed into smaller tasks and distributed, and business process definitions are used to capture the processing steps involved, both employees and computers are often modeled as computing resources for scheduling processing steps, with only the occasional use of resource inter-connection and skill-set profile matching. More complete automation of such processes, such as by eliminating the human component and introducing more efficient access to information, is highly desirable.

### BRIEF DESCRIPTION OF THE DRAWINGS

FIGS. 1A are 1B illustrate a flow chart for a method of processing information according to an embodiment of the present invention;

FIG. 2 is a block diagram of an article, including a machine-accessible medium, according to an embodiment of the present invention; and

FIG. 3 is a block diagram of a system and an article, including a machine-accessible medium, according to various embodiments of the present invention.

### DESCRIPTION OF THE PREFERRED EMBODIMENTS

A system, an article including a machine-accessible medium, and a method for processing information which operate to increase the speed at which information is accessed, as well as the speed at which appropriate processing resources can be located and used, would therefore be useful. This is especially true with regard to coordinating access to the information and resources, such that an automated, defined process adapted to use selected information and communicate with designated resources may be implemented in an efficient manner.

In the following detailed description of the invention, reference is made to the accompanying drawings which form a part hereof, and in which are shown by way of illustration, and not of limitation, specific embodiments in which the invention may be practiced. In the drawings, like numerals describe substantially similar components throughout the several views. The embodiments illustrated are described in sufficient detail to enable those skilled in the art to practice the invention. Other embodiments may be utilized and derived therefrom, such that structural and logical substitutions and changes may be made without departing from the scope of the invention. The following detailed description, therefore, is not to be taken in a limiting sense, and the scope of the invention is defined only by the appended claims, along with the full range of equivalents to which such claims are entitled.

The invention, in each of several embodiments, permits a group of distributed, loosely-coupled, heterogeneous computers to optimize the execution of tasks within a defined process by pre-fetching data and distributing the process tasks to previously-identified and bound computing resources. Advantages of this approach include enabling pre-assembly of the execution environment (which may in turn enable the use of spare computer time or processing cycles and unused communication bandwidth), along with automatic, timely updates of portions of the environment which become stale before execution commences.

A process may be defined to include four parts: the process definition, services, data, and run-time. The process definition includes the sequence of operations, or tasks, required to achieve a selected goal, such as reserving a series of seats in a sports arena. Services expose operations that may be performed on data, which may be local, or remote from the operative services. Services also define the data format to be used by the service. The process run-time includes scheduling resources to perform the tasks, and monitoring the results of execution to ensure that progress toward achieving the selected goal actually occurs.

Some of the difficulties involved in goal-oriented process execution include pre-process, or mid-process changes which occur to data, resources, and even to the process itself. Data structures or values may change between the time a process is defined, and the time of execution. Services (which are a type of resource), or elements of services, such as service interfaces, may also be altered. Thus, the information needed by the process must either be supplied prior to any changes, or after an update occurs such that the process can take advantage of the updated information.

Resource binding, which includes associating specific sources of data with specific services within a process, may occur prior to execution, during execution, or both, due to system failures, network failures, priority mismatches, or security mismatches. Thus, a mechanism for determining the existence of alternate resources must also be provided.

To resolve these difficulties, a multi-part approach is used. The invention provides novel resource binding information, or hints/rules which aid in locating appropriate resources; revision control primitives embedded within selected data, service interfaces, and process tasks; and support services that may aid resource binding due to additional knowledge of resource availability. This approach allows configuring data, operational rules, process tasks, and access control policies to assist in selecting resources for participation in the distributed execution process. Configurations can then be cached and updated as necessary. Information revision tags can also be used to notify tasks of cache updates, such that each task has the option of taking advantage of new information when it becomes available.

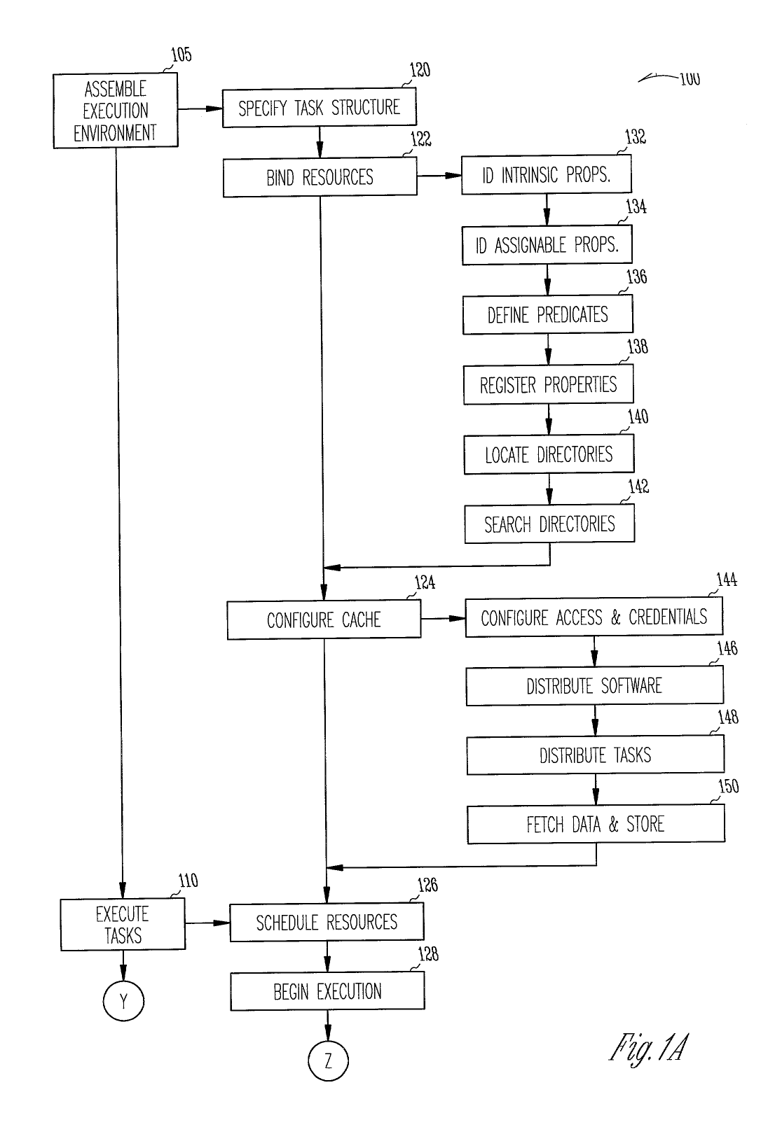

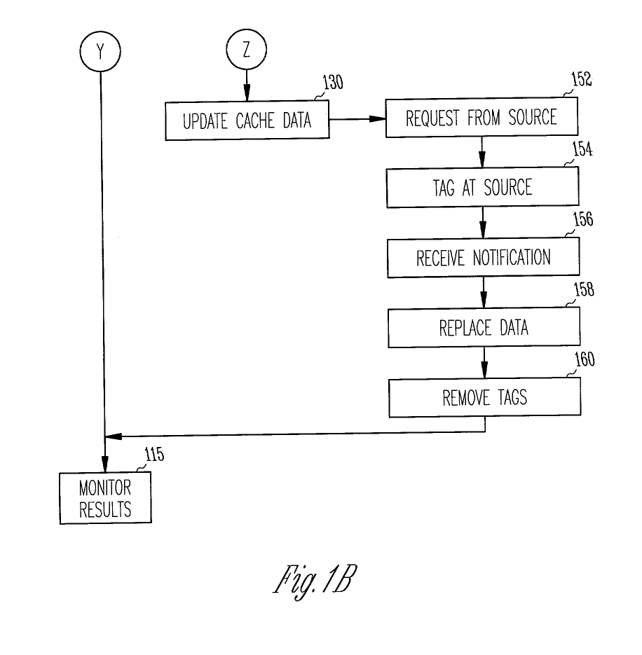

FIGS. 1A and 1B are a flow chart for a method of processing information according to an embodiment of the present invention. At the highest level of abstraction, the method 100 may include assembling the execution environment at block 105 (i.e., assembly prior to execution), executing the defined tasks at block 110, and then monitoring the results associated with the execution of one or more selected tasks at block 115.

As the method 100 is broken down into smaller parts, it can be seen that pre-assembling the execution environment may include specifying a process definition task structure to include a plurality of tasks at block 120, dynamically binding a plurality of selected resources to the tasks at block 122, and configuring a cache to store one or more process information elements included in the tasks at block 124. The cache may also be configured to store the most recent values of selected data. Task execution (at block 110) may include scheduling the resources to execute the tasks (at block 126), beginning execution of the tasks (at block 128), and updating or revising the values of data stored in the cache (at block 130) as execution progresses. Specifying the process definition task structure at block 120 involves defining the process as a set of tasks and conjunctive logic. Each process definition is distinguished by a name and/or other identifier. Instances of a process definition may also have an instance identifier, and include execution status information. A pseudo-code definition structure may be set forth in Backus-Naur format as follows:

Process ::=<Process Header><Process Body><Process State>
Process Header ::=<Process Template Name><Process Template

Revision><Process Template Identifier>

Process Body ::=<Tasks and Conditions> | <Tasks>
Process State ::=<Process Instance ID><Process Execution Status><Current

Task><Task Results>

Task Results ::=<Task Result> | <Task Result><Task Results>
Task Result ::=<Task ID><Datum><Revision>
Tasks ::=<Task> | <Task>, <Tasks>
Task ::=<Task ID><Operation>@<Service Location>via<Entity>
Operation ::=<Service Type><Interface Definition><Parameter Data>
Parameter Data ::=<Parameter> | <Parameter>, <Parameter Data>
Parameter ::=<Datum><Revision>@<Data Location>via<Entity>
Datum ::=<Opaque Data Type><Opaque Data Format>
Process Template Name ::=<name>
Process Template Revision ::=<Revision>
Process Template ID ::=<IDsymbol>
Process Instance ID ::=<IDsymbol>
Process Execution Status ::=<CharData>
Current Task ::=<Task>
Task ID ::=<IDsymbol>
Service Type ::=<IDsymbol>
Service Location ::=<URI-reference>
Interface Definition ::=<IDL Interface> (See, for example, the Object

Management Group, Inc. Interface Definition Language (IDL)
document, CORBA 2.5, Chapter 3, IDL Syntax and Semantics,
posted at http://www.omg.org/cgi-bin/doc?formal/01-09-40)

Revision ::=<VersionNum>
Data Location ::=<URI-reference>
Opaque Data Format ::=<Idsymbol>
Entity ::=<name>
Predicate ::=(<Condition>) | <Predicate> <LogicOperator><Predicate>
LogicOperator ::=AND | OR
Condition ::= <Value> <BoolOp> <Value>
BoolOp ::=> | < | = | != | >= | <=
Value ::=<SystemLiteral> | <Task>
URI-reference ::=string, interpreted per [Uniform Resource Identifier (URI),

or Uniform Resource Locator (URL)]

IDsymbol ::=(any legal XML name symbol) (See, for example, the

Extensible Markup Language (XML) 1.0 (Second Edition) document
according to the World Wide Web Consortium (W3C)
Recommendation of 6 October 2000 published at
http://www.w3.org/TR/REC-xml#NT-Nmtoken)

name ::=(any legal XML name symbol)
string ::=(any XML text, with “<”, “>”, and “&” escaped)
VersionNum ::= ([a-zA-Z0-9_.:]|‘−’)+
SystemLiteral ::= (″″[ˆ ″]* ″″) | (″″[ˆ ′]* ″″)
PubidLiteral ::= ″″PubidChar* ″″ | ″″ (PubidChar − ″″)* ″″
PubidChar ::= #x20 | #xD | #xA | [a-zA-Z0-9] | [−′0+,./:=?;!*#@$_%]
CharData ::= [ˆ <&]* −([ˆ <&]* ′]]>′ [ˆ <&]*)
Char ::= #x9 | #xA | #xD | [#x20-#xD7FF] | [#xE000-#xFFFD] | [#x10000-
#x10FFFF](* any Unicode character, excluding the surrogate blocks,
FFFE, and FFFF. *)

In this case, the <revision> for a Task Result may be a monotonically increasing integer, such as a version number. A <service location> for a Task may be the location of an <entity> in a network, as denoted by a universal resource locator (URL) address, or an internet protocol (IP) address and port number; an <entity> may be an abstract reference to a node in the network. Examples of <opaque data type> for a Datum include the extensible markup language (XML) type, the XML-document type definition (DTD) type, the multipurpose internet mail extension (MIME) type, and a base64 (ascii character) encoded file. Further information regarding the defined elements within the definition structure may be found in the Resource Description Framework (RDF) Model and Syntax Specification, according to the W3C Recommendation Feb. 22, 1999, published at http://www.w3.org/TR/REC-rdf-syntax/, and similar documents.

The Task and Parameter elements typically require resource binding prior to execution. They may be defined as follows prior to binding, so as to include rules/hints which aid in the discovery of appropriate resources:

Task ::= <Task ID><Operation>@<Service Discovery Location><Resource

Profile>

Parameter ::= <Datum><Revision>@<Data Discovery

Location><Repository Profile>

Thus, instead of the actual locations of services or data, the predicate may instead contain search criteria and references to directories which perform the search for the locations. Dynamic binding is enabled in this manner, and, if the process definition preserves the binding hints/rules after initial binding is accomplished, re-binding may occur based upon environmental factors, such as resource availability.

Dynamically binding selected resources to tasks (at block 122) may include identifying intrinsic properties associated with designated resources at block 132, identifying assignable properties associated with the designated resources at block 134, and defining query predicates associated with the designated resources at block 136.

Intrinsic properties describe capabilities of resources that can not easily be changed or assigned, such as physical characteristics (e.g., geographic location), processing capacity (e.g., clock speed, memory size, or disk space), interface limitations (e.g., availability), and other relatively immutable characteristics. Even data may possess intrinsic properties, such as formats, size, update frequency, age, and access privileges (e.g., private keys). The task structure defined at block 120 may allow multiple configurations of intrinsic properties, but matching criteria is preferably obtained from only a single configuration.

Resources may also have properties or capabilities that can be assigned. Such properties, including titles, roles, groups, names, aliases, software configurations and/or modules, libraries, and applications, may be used to qualify a search identifying resources appropriate to each task. Using both intrinsic and assignable properties, query predicates may be created (at block 136). Predicate logic specifies resource properties and acceptable value ranges.

Dynamically binding selected resources to tasks may also include registering the intrinsic and assignable properties with one or more resource directories (which in turn may constitute a resource—recursively defined) at block 138, locating resource directories including those directories at which registration occurred (at block 140), and searching resource directories to find selected resources which are associated with, or match up with, the designated resources at block 142.

Thus, profile information (e.g., properties) describing each designated resource may be forwarded to directories having optimized search capability and availability, so that even the searching/location process may be enhanced. Selected hosts may even be specified to search for suitable resources.

After resources are chosen based, in part, on location and identity, they may be associated with, or bound to process tasks. The process definition may even be re-written to provide alternate forms of tasks based on selected resources. Thus, criteria for choosing resources may be included directly in the process definition, and associated with one or more process tasks. This mechanism helps preserve correlation between resources and tasks. Further, using dynamic resource location with specified criteria, rather than strict reliance on direct resource specification, allows binding resources during task execution. The process can then be more responsive to environmental changes, including resource availability.

Therefore, it can be seen that resource binding at block 122 may include the specification of suitable resources, resource registration with a resource directory, searching registered resources, and determining their suitability for use during task execution. In fact, discovering directories which support resource binding is itself part of the resource binding process. Thus, specification of suitable resources may also include rules/hints for discovering appropriate directories.

Binding resources to each task also enables distribution of tasks according to natural boundaries; e.g., each task may be performed on a different host computer, if desired. Similarly, criteria for locating information repositories, such as a Universal Description, Discovery, and Integration (UDDI) registry, may be included in the process definition. Such criteria may include factors such as cost, availability, freshness, locality, and content. Data sources can then also be selected in a dynamic fashion, such that multiple remote data sources required for a single task are easily accommodated.

Resources performing tasks during execution may use cached process elements. Thus, process elements, which may include task definitions, data, access and control rules, credentials, software modules, and other items may be stored in the cache as part of the pre-assembly process. Such process elements typically include those invoked as a consequence of performing selected tasks after resources have been bound to them. Configuring the cache to store process information elements and/or data (block 124) may include configuring access control rules associated with the selected resources, and delivering or distributing access credentials associated with the access control rules to selected resources at block 144.

Access control rules define entities, resources, and acceptable interaction semantics. The process definition, therefore, acts as a model for access control. By extrapolating the access control model from the process definition, and taking resource binding decisions into consideration, access control rules and credentials can be generated. Entities performing tasks should be allowed to submit requests to execute tasks or access data. Hence, access control list entries, derived from the process definition, are delivered to various entities which will eventually receive work requests (as set forth in the process definition).

Entities making requests must have the credentials which entitle them to make the requests. Credentials identify tasks in the process definition, associating them with the requestors, which can be termed “key holders”. A cache of credentials may be created at each entity using the process definition as a distribution plan, or roadmap. Credentials can be delivered securely (without losing integrity) if the receiving entity has previously authenticated the distributor (i.e., the entity priming the cache holding the credential). The distributor may also select the expiration period for credentials it distributes.

Configuring the cache may also include distributing one or more software modules to selected resources at block 146, and distributing the tasks to the selected resources at block 148. Finally, configuring the cache may include pre-fetching one or more datum values and storing them in the cache at block 150. Process definition tasks identify interfaces, programs, objects, and interpreters that may be invoked as part of executing the tasks. Services and/or resources which do not have the necessary interfaces, programs, objects or interpreters (or the appropriate versions) may be updated accordingly, or bypassed in favor of more immediately qualified services/resources. The agent performing software distribution may use profile information (i.e., properties) to determine which modules should be installed. Alternatively, resources may be queried directly to determine their profile information.

After resources are bound, the process definition may indentify specific resources to perform specific tasks. The process definition may be dissected into portions based on the resources to which the tasks will be assigned, and thereafter distributed among the resources. The tasks may then be cached until requests are made for their execution.

Process tasks may contain data references. Data may therefore be pre-fetched and stored in one or more caches, especially when the probability of future change is low. Pre-fetching enables localized processing during execution for optimal performance, as well as off-line (disconnected) operations. Executing tasks will typically attempt to locate data in the cache prior to seeking the data remotely.

Task execution (at block 128) may be triggered using requests arising from application activity, or the occurrence of external events. Tasks from different processes may execute simultaneously. Invocation request messages may be distributed to multiple servers, resulting in parallel-distributed execution. Requests may also be buffered, prior to scheduled local execution. Once scheduled, a process becomes active, such that internal execution states are also maintained.

Cache configuration operations may be performed in any order prior to the execution of tasks within a process. To maintain execution integrity, pre-fetched contents of the cache may be locked while process tasks execute. Should a distributor of data update a cached element, the update may be queued and applied after execution is complete. Newly updated cached elements may carry revision information as part of their definition, such that tasks can make use of the latest version of the information they need, or simply ignore updates and use whatever is in the cache at the moment of execution. Therefore, state information may be included as part of cache configuration to prevent updates from impairing processes already undergoing execution.

Thus, pre-fetched elements may carry version information. Alternatively, a reference to the latest version may be made. If this is the case, information updates must be propagated to cached copies so that the information will not become stale and off-line operations may occur without taking time to refresh external dependencies on cached elements.

Hence, updating or revising data stored in the cache may include requesting the values of the data from one or more data sources or repositories, such as a (UDDI) data repository, at block 152. Updating the cached data may also include marking selected data at the source of the data using a tag associated with one or more selected tasks (which also may be stored in the cache) at block 154, receiving an update notification for one or more of the data values at block 156, and replacing data values for which notifications were received with the updated values at block 158. Finally, updating the cache may include removing tags associated with tasks that have been purged from the cache at block 160.

Thus, when a cached data element is requested, the request typically includes version or revision information. The datum is returned to the requestor after inclusion of the requestor in the access list is checked. If the most recent version is requested, the data repository logs the request by tagging the element and including information about the requester (so that a follow-up message can be routed to the requestor). Thereafter, the repository monitors changes to the tagged element.

If the tagged element is updated by the repository, the log of requesters associated with the element is consulted and a notification message containing the new datum value, or instructions for fetching the new value, is constructed. Updates may be synchronized across multiple requesters, if for example, the process definition specifies the same element is to be used in multiple tasks. Thus, update notification is typically performed as a transaction that updates all requesters atomically.

If cached process steps including references to a tagged element are purged, a message notifying the repository of expiration is sent so that update tags can be removed. If cached elements including data references expire, related tags are also removed. It should be noted that data references (e.g., universal resource locators) are also considered to be data. Hence, changes to path names affecting data references can also be propagated to requesters so that process tasks including data references are kept current.

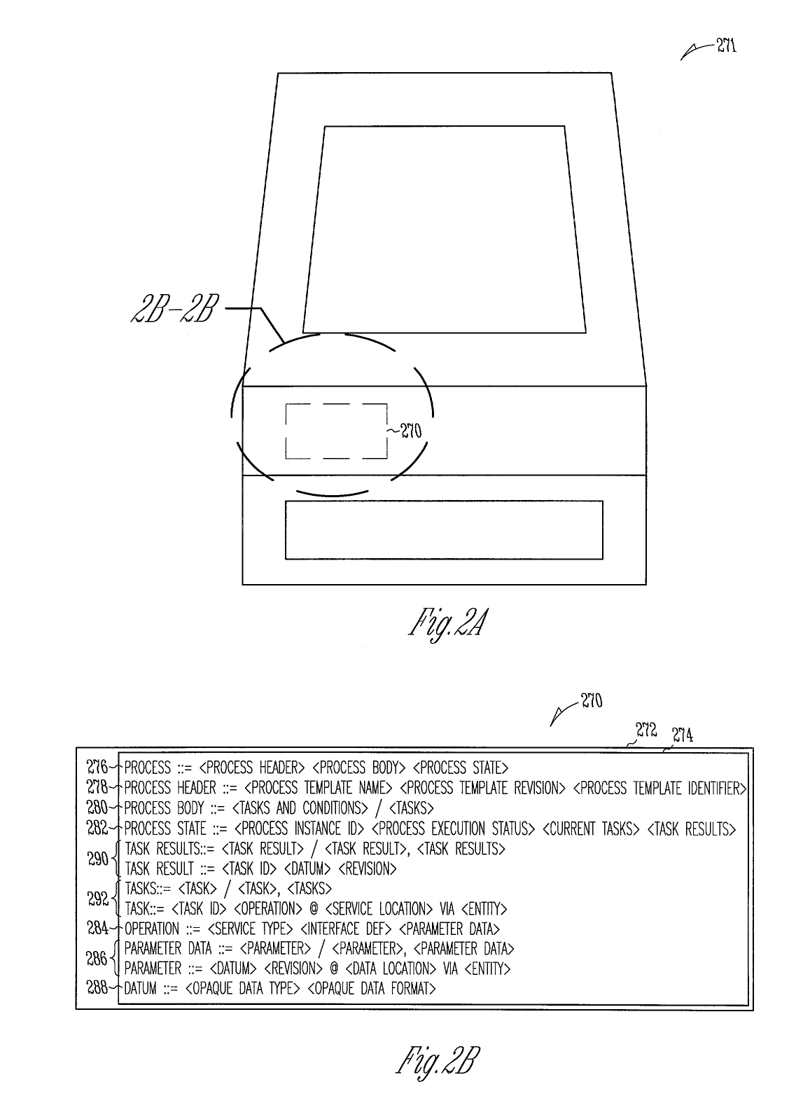

A block diagram of an article, including a machine-accessible medium, according to an embodiment of the present invention can be seen by referring to FIG. 2. In this case, the article 270, such as a memory chip, a memory system, a magnetic or optical disk, some other storage device, and/or any type of electronic device or system, may be incorporated as an element of a computing device, for example, a computer 271. The article 270, comprising a machine-accessible medium 272 (e.g., an electrical, optical, or electromagnetic conductor) includes associated data 274, which when accessed, results in a machine performing a process 276 which may include specifying a process header 278, a process body 280 (including a plurality of tasks), and a process state 282 (which may include execution state information).

Specifying the process body 280 may further include specifying one or more operations 284 conducted at a resource discovery location by a selected resource having a resource profile. Specifying operations 284 may include specifying a service type, an interface definition, and parameter data. In turn, specifying the parameter data 286 may include specifying a datum to be revised at a data discovery location by a selected repository having a repository profile. Of course, specifying the datum 288 may include specifying the datum type and format. Specifying the process state 282 may include specifying a process instance identification, a process execution status, and one or more task results 290 associated with selected tasks 292.

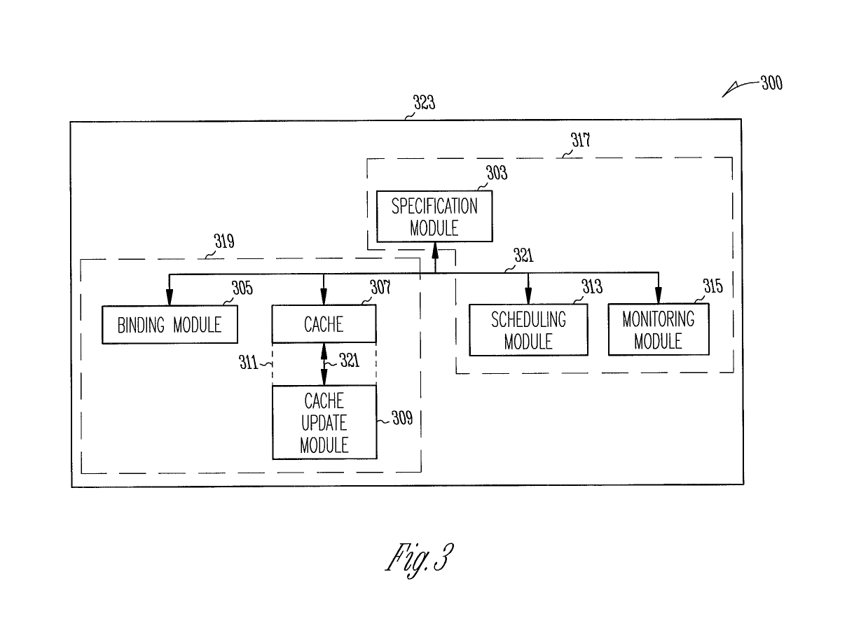

FIG. 3 is a block diagram of a system and an article, including a machine-accessible medium, according to various embodiments of the present invention. In one embodiment of the invention, an information processing system 300 may include a specification module 303 to specify a process definition task structure (including a plurality of tasks similar to or identical to the pseudo-code listed above), and a binding module 305, which is used to dynamically bind selected resources to the tasks. The binding module 305 is capable of being communicatively coupled to the specification module 303.

The system 300 may also include a cache 307 to store process information elements and/or data. The cache 307 is also capable of being communicatively coupled to the specification module 303, as well as to a cache update module 309. The cache 307 and the update module 309 may form a single unit or module 311, or may exist as separate modules 307, 309.

The system 300 may also include a scheduling module 313 to schedule the selected resources for task execution, and the scheduling module 313 is capable of being communicatively coupled to the specification module 303. Finally, the system 300 may include a monitoring module 315 to monitor the results associated with executing the tasks. The monitoring module 315 is also capable of being communicatively coupled to the specification module 303.

While many system 300 configurations are possible, it is certainly possible to design the system 300 such that the specification module 303 and the scheduling module 313 are included in a single computer, such as a specification computer 317. Similarly, the binding module 305 and the cache 307, as well as the update module 309, may be included as elements of another computer 319 capable of being communicatively coupled to the specification computer 317.

It should be noted that the specification module 303, the binding module 305, the cache 307, the cache update module 309, the scheduling module 313, and the monitoring module 315 may all be characterized as “modules” herein. Such “modules” may include hardware circuitry, such as a microprocessor and memory, software program modules, or firmware, and combinations thereof, as desired by the architect of the system 300, and appropriate for particular implementations of the invention. Similarly, the medium or media 321 used for communicatively coupling the modules 303, 305, 307, 309, 313, and 315, as well as computers 317 and 319 may be an electrical conductor, and optical conductor, a radio frequency wave, or a combination of these.

One of ordinary skill in the art will understand that the information processing system 300 of the present invention can be used in applications other than for computers, and thus, the invention is not to be so limited. The illustrations of an information processing system 300, a computer 271, and the article 270 are intended to provide a general understanding of the structure of the present invention, and are not intended to serve as a complete description of all the elements and features of information processing systems, computers, and articles which might make use of the structures described herein.

Applications which may include the novel information processing system, article, and computer of the present invention include electronic circuitry used in high-speed computers, device drivers, communication and signal processing circuitry, modems, processor modules, embedded processors, and application-specific modules, including multilayer, multi-chip modules. Such information processing systems, articles, and computers may further be included as sub-components within a variety of electronic systems, such as televisions, cellular telephones, personal computers, radios, aircraft, and others.

Thus, referring back to FIG. 3, it is now easily understood by those skilled in the art that another embodiment of the invention may include an article 323, comprising a machine-accessible medium 321 having associated data (located in each of the modules 303, 305, 307, 309, 313, and 315), which when accessed, results in a machine performing the method illustrated in FIGS. 1A and 1B. Such actions may include executing instructions (e.g., a program) which result in specifying a process definition task structure (including a plurality of tasks), dynamically binding selected resources to the tasks, configuring a cache to store one or more process information elements included in the tasks and/or data associated with values, scheduling the resources to execute the tasks, and executing the tasks. Other actions may include identifying intrinsic and assignable properties associated with designated resources, and defining query predicates associated with the designated resources. Additionally, the actions may include registering the intrinsic and assignable properties with one or more resource directories, locating resource directories (including the registration directories), and searching the located resource directories to find the selected resources associated with the designated resources.

Other actions may include revising the values of data stored in the cache, which may in turn include requesting the value of a datum from a data source, marking the datum at the data source using a tag (which may be associated with one of the tasks selected from those stored in the cache), receiving an update notification for the value of the datum, and replacing the value of the datum in the cache with an updated value for the datum.

Several advantages accrue from various embodiments of the invention, which enables the locations and selection of resources for performing process tasks to be discovered based on embedded search criteria and other rules/hints. This is an advance over the prior art, wherein a central controller simply waits for resources to present themselves. Further, while the prior art encourages manual construction of the execution environment, illustrated embodiments of the invention provide for dynamic construction, with a high degree of automation.

Using the illustrated embodiments, the execution environment may be cached, instead of depending on access to a central controller or work queues. This enables participants in the process to more easily perform tasks apart from a network connection. This is especially important for mobile participants, which may not always have network access, or the desire to pay for it. In addition, the increased availability of resources enabled by the invention provides a foundation for automated synchronization of dissimilar parts when connectivity is lost, and then re-established. This is in contrast to the prior art, wherein fixed resource partitions result in decreased consistency and availability.

Thus, the process definition of illustrated embodiments of the invention provides intelligent use of network bandwidth and other system resources within a structured, albeit adaptable, execution environment. Flexibility is obtained by trading availability for consistency, instead of assuming centralized consistency and fixed resources which readily connect to a central server.

The system, articles, and method of various embodiments of the invention therefore provide an additional tool which can be used by computer system designers and programmers alike to increase information processing efficiency. The use of the method, system, and articles disclosed herein operate to increase the speed at which information is accessed, as well as the speed at which appropriate processing resources can be located and used. Also improved is the ability to coordinate access to information and resources, such that a specified process may be adapted to use selected information and communicate with designated resources in a more efficient manner.

Although specific embodiments have been illustrated and described herein, those of ordinary skill in the art appreciate that any arrangement which is calculated to achieve the same purpose may be substituted for the specific embodiment shown. This disclosure is intended to cover any and all adaptations or variations of the present invention. It is to be understood that the above description has been made in an illustrative fashion, and not a restrictive one. Combinations of the above embodiments, and other embodiments not specifically described herein will be apparent to those of skill in the art upon reviewing the above description. The scope of the invention includes any other applications in which the above structures and methods are used. The scope of the invention should be determined with reference to the appended claims, along with the full range of equivalents to which such claims are entitled.

What is claimed is:

1. A method, comprising:
specifying a process definition task structure including a plurality of tasks;
dynamically binding a plurality of selected resources to the plurality of tasks;
configuring a cache to store at least one process information element included in the plurality of tasks and at least one datum having a value;
scheduling the plurality of resources to execute the plurality of tasks; and
executing the plurality of tasks.

2. The method of claim 1, wherein dynamically binding a plurality of selected resources to the plurality of tasks further comprises:
identifying a plurality of intrinsic properties associated with a plurality of designated resources;
identifying a plurality of assignable properties associated with the plurality of designated resources; and
defining a plurality of query predicates associated with the plurality of designated resources.

3. The method of claim 2, wherein dynamically binding a plurality of selected resources to the plurality of tasks further comprises:
registration of the pluralities of intrinsic and assignable properties with at least one resource directory;
locating a plurality of resource directories including the at least one resource directory; and
searching the plurality of resource directories to find the plurality of selected resources associated with the plurality of designated resources.

4. The method of claim 1, wherein configuring a cache to store at least one process information element included in the plurality of tasks and at least one datum having a value further comprises:
configuring a plurality of access control rules associated with the plurality of selected resources; and
delivering a plurality of access credentials associated with the plurality of access control rules to the plurality of selected resources.

5. The method of claim 1, wherein configuring a cache to store at least one process information element included in the plurality of tasks and at least one datum having a value further comprises:
distributing at least one software module to at least one of the plurality of selected resources; and
distributing the plurality of tasks to the plurality of selected resources.

6. The method of claim 1, wherein configuring the cache to store at least one process information element included in the plurality of tasks and at least one datum having a value further comprises:
pre-fetching the value of the at least one datum; and
storing the value of the at least one datum in the cache.

7. The method of claim 1, further comprising:
revising the value of the datum stored in the cache.

8. The method of claim 7, wherein revising the value of the datum stored in the cache further comprises:
requesting the value of the datum from a data source;
marking the datum at the data source using a tag associated with a selected one of the plurality of tasks stored in the cache;
receiving an update notification for the value of the datum; and replacing the value of the datum with an updated value for the datum.

9. The method of claim 8, further comprising:
removing the tag when the selected one of the plurality of tasks is purged from the cache.

10. The method of claim 1, further comprising:
monitoring a plurality of results associated with executing the plurality of tasks.

11. An information processing system, comprising:
a specification module to specify a process definition task structure including a plurality of tasks;
a binding module to dynamically bind a plurality of selected resources to the plurality of tasks, the binding module capable of being communicatively coupled to the specification module;
a cache to store at least one process information element included in the plurality of tasks and at least one datum having a value, the cache capable of being communicatively coupled to the specification module; and
a scheduling module to schedule the plurality of resources to execute the plurality of tasks, the scheduling module capable of being communicatively coupled to the specification module.

12. The information processing system of claim 11, further comprising:
a cache update module capable of being communicatively coupled to the cache.

13. The information processing system of claim 11, further comprising:
a monitoring module to monitor a plurality of results associated with executing the plurality of tasks, the monitoring module capable of being communicatively coupled to the specification module.

14. The information processing system of claim 11, wherein the specification module and the scheduling module are included in a first computer.

15. The information processing system of claim 14, wherein the binding module and the cache are included in a second computer capable of being communicatively coupled to the first computer.

16. An article comprising a machine-accessible medium having associated data, wherein the data, when accessed, results in a machine performing:
specifying a process definition task structure including a plurality of tasks;
dynamically binding a plurality of selected resources to the plurality of tasks;
configuring a cache to store at least one process information element included in the plurality of tasks and at least one datum having a value;
scheduling the plurality of resources to execute the plurality of tasks; and
executing the plurality of tasks.

17. The article of claim 16, wherein the machine-accessible medium further includes data, which when accessed by the machine, results in the machine performing:
identifying a plurality of intrinsic properties associated with a plurality of designated resources;
identifying a plurality of assignable properties associated with the plurality of designated resources; and
defining a plurality of query predicates associated with the plurality of designated resources.

18. The article of claim 17, wherein the machine-accessible medium further includes data, which when accessed by the machine, results in the machine performing:
registration of the pluralities of intrinsic and assignable properties with at least one resource directory;
locating a plurality of resource directories including the at least one resource directory; and
searching the plurality of resource directories to find the plurality of selected resources associated with the plurality of designated resources.

19. The article of claim 16, wherein the machine-accessible medium further includes data, which when accessed by the machine, results in the machine performing:
revising the value of the datum stored in the cache.

20. The article of claim 16, wherein the machine-accessible medium further includes data, which when accessed by the machine, results in the machine performing:
requesting the value of the datum from a data source;
marking the datum at the data source using a tag associated with a selected one of the plurality of tasks stored in the cache;
receiving an update notification for the value of the datum; and
replacing the value of the datum with an updated value for the datum.

21. An article comprising a machine-accessible medium having associated data, wherein the data, when accessed, results in a machine performing:
specifying a process body including a plurality of tasks; and
specifying a process state having execution state information.

22. The article of claim 21, wherein specifying the process body further comprises:
specifying at least one operation conducted at a resource discovery location by a selected resource having a resource profile.

23. The article of claim 22, wherein specifying the at least one operation further comprises:
specifying a service type, an interface definition, and parameter data.

24. The article of claim 23, wherein specifying the parameter data further comprises:
specifying a datum to be revised at a data discovery location by a selected repository having a repository profile.

25. The article of claim 21, wherein specifying the process state further includes:
specifying a process instance identification, a process execution status, and at least one task result associated with a selected one of the plurality of tasks.
